(19) United States
(12) Patent Application Publication
(10) Pub. No.: US 2017/0112715 A1
(43) Pub. Date: Apr. 27, 2017

(54) Massage Assembly

(71) Applicant: Tawana Robinson, Brooklyn, NY (US)

(72) Inventor: Tawana Robinson, Brooklyn, NY (US)

(21) Appl. No.: 14/921,197

(22) Filed: Oct. 23, 2015

(51) Int. Cl. A61H 23/02; A61H 15/00

(52) U.S. Cl. CPC A61H 23/0254; A61H 15/00; A61H 2205/02; A61H 2015/0042

(57) ABSTRACT

A massage assembly for relieving symptoms of a head ache includes a collar that may be worn on a head. A pair of massage units is provided and each of the massage units is coupled to the collar. Each of the massage units abuts the head when the collar is worn on the head. Thus, each of the massage may massage the head.

### BACKGROUND OF THE DISCLOSURE

### Field of the Disclosure

The disclosure relates to massage devices and more particularly pertains to a new massage device for relieving symptoms of a head ache.

### SUMMARY OF THE DISCLOSURE

An embodiment of the disclosure meets the needs presented above by generally comprising a collar that may be worn on a head. A pair of massage units is provided and each of the massage units is coupled to the collar. Each of the massage units abuts the head when the collar is worn on the head. Thus, each of the massage may massage the head.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective in-use view of a massage assembly according to an embodiment of the disclosure.

FIG. 2 is a back view of an embodiment of the disclosure.

FIG. 3 is a cross sectional view taken along line 3-3 of FIG. 2 of an embodiment of the disclosure.

FIG. 4 is a schematic view of an embodiment of the disclosure.

FIG. 5 is a perspective view of an embodiment of the disclosure in a stored position.

### DESCRIPTION OF THE PREFERRED EMBODIMENT

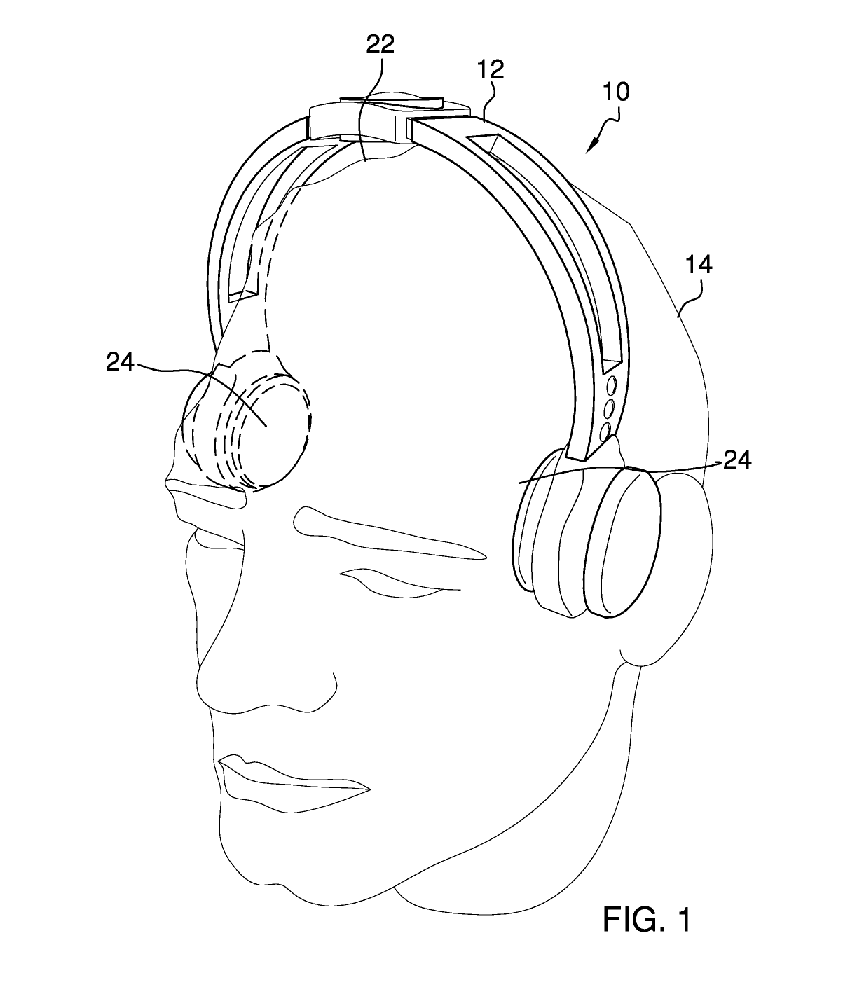

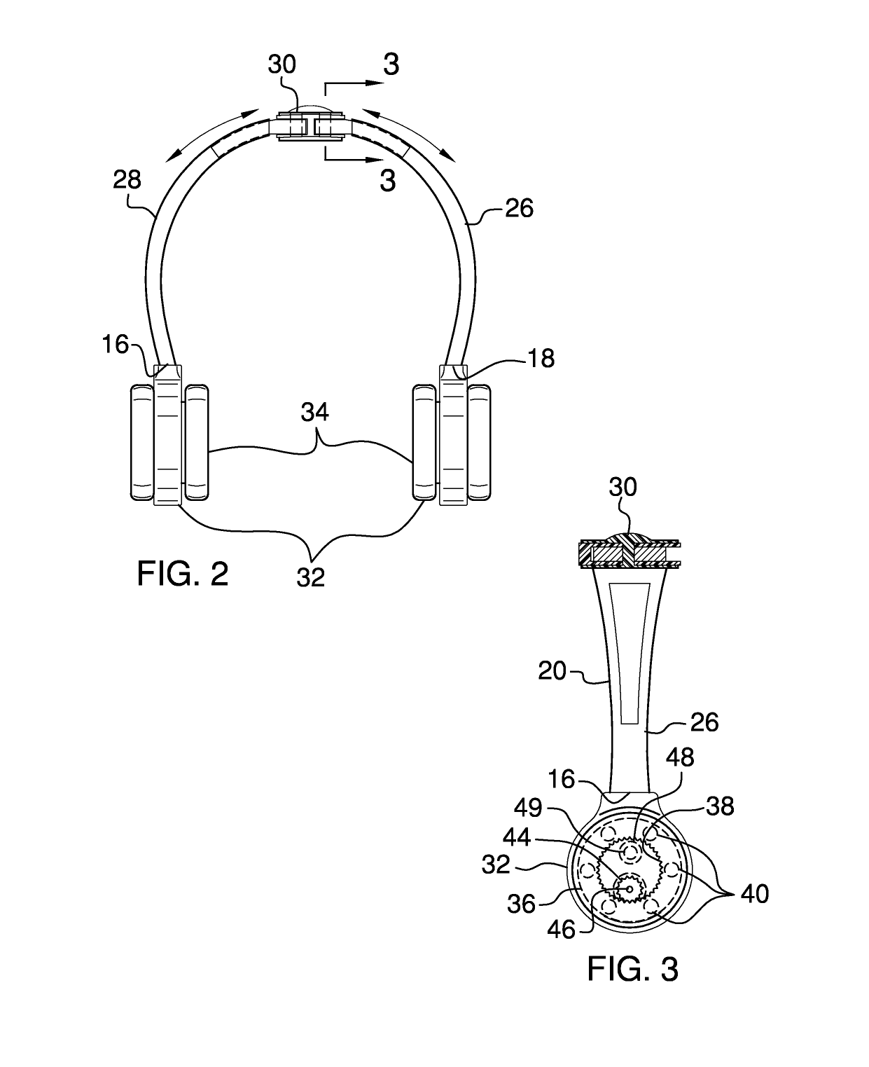

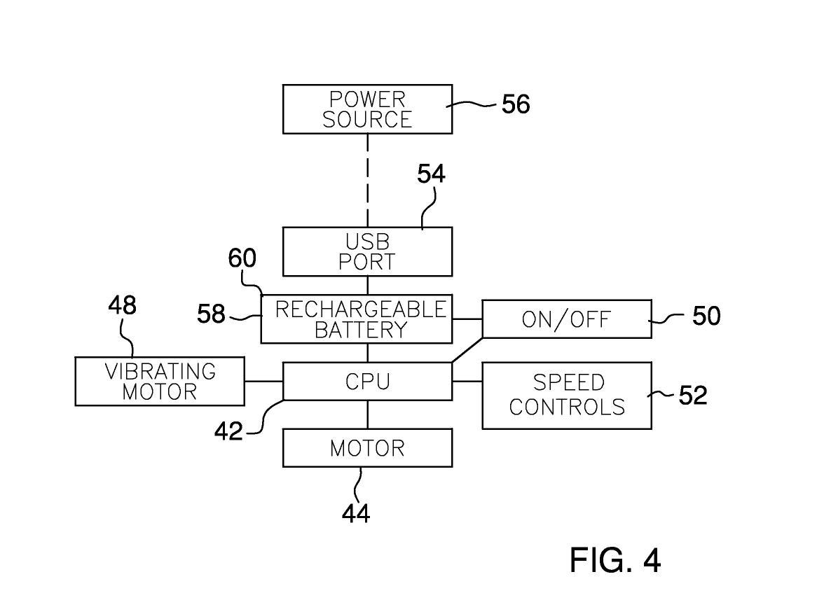

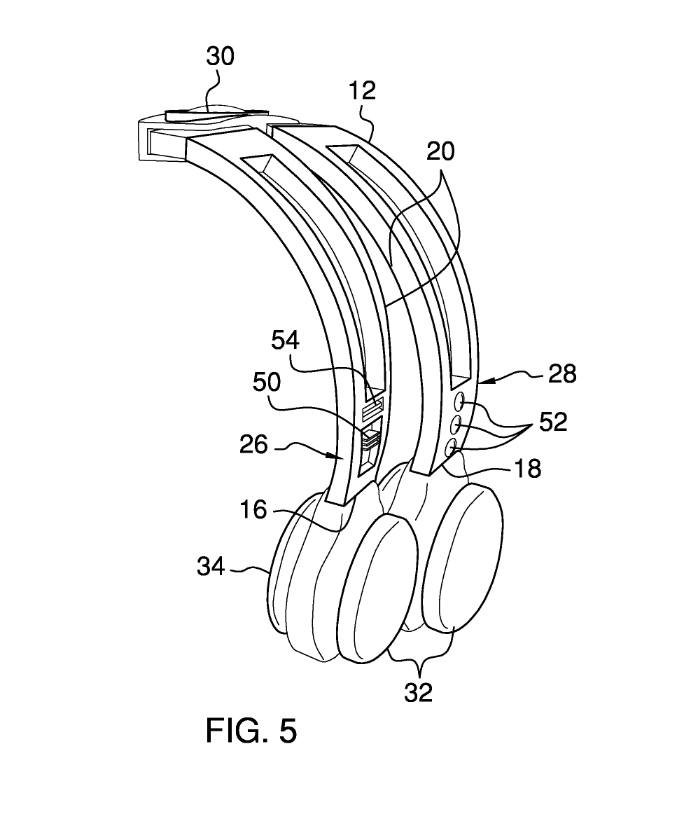

With reference now to the drawings, and in particular to FIGS. 1 through 5 thereof, a new massage device embodying the principles and concepts of an embodiment of the disclosure and generally designated by the reference numeral 10 will be described.

As best illustrated in FIGS. 1 through 5, the massage assembly 10 generally comprises a collar 12 that may be worn on a head 14. The collar 12 has a first end 16, a second end 18 and a front edge 20. The collar 12 is curved between the first end 16 and the second end 18 such that the collar 12 has a U-shape. Thus, the collar 12 may be positioned on a crown 22 of the head 14 having the first end 16 and the second end 18 being aligned with an associated one of a pair of temples 24 on the head 14.

The collar 12 is split between the first end 16 and the second end 18 to define a first half 26 of the collar 12 and a second half 28 of the collar 12. The collar 12 includes a pivot 30 and each of the first half 26 and the second half 28 is movably coupled to the pivot 30. The collar 12 is positionable in a deployed position having the first half 26 being longitudinally aligned with the second half 28 thereby forming the U-shape. The collar 12 is positionable in a stored position having the front edge 20 corresponding to the first half 26 being positioned adjacent to the front edge 20 corresponding to the second half 28.

A pair of massage units 32 is provided and each of the massage units 32 is coupled to the collar 12. Each of the massage units 32 abuts the head 14 when the collar 12 is worn on the head 14 thereby facilitating each of the massage units 32 to massage the head 14. Each of the massage units 32 has a first surface 34. Each of the massage units 32 is positioned on an associated one of the first end 16 and the second end 18. Thus, the first surface 34 abuts an associated one of the temples 24. Each of the massage units 32 may massage an area proximate a temporal artery.

The first surface 34 of each of the massage units 32 is comprised of a deformable material. Each of the massage 32 units includes a ring 36 that is rotatably positioned within each of the massage units 32 and the ring 36 has an inner edge 38. A plurality of balls 40 is provided and each of the balls 40 is coupled to the ring 36. The balls 40 are spaced apart from each other and are distributed around the ring 36. Each of the balls 40 is positioned between the ring 36 and the first surface 34. Thus, each of the balls 40 urges the first surface 34 to frictionally engage the head 14.

Each of the massage units 32 includes a processor 42. The processor 42 may comprise an electronic processor or the like. A first motor 44 is positioned within each of the massage units 32. The first motor 44 may comprise an electric motor or the like.

A gear 46 is rotatably coupled to the first motor 44. The gear 46 engages the inner edge 38 of the ring 36. Thus, the first motor 44 rotates the ring 36 when the first motor 44 is turned on such that each of the massage units 32 massages the associated temple 24. Each of the balls 40 is urged to travel in a circle such that the balls 40 massage the area proximate the temporal artery.

A second motor 48 is positioned within the each of the massage units 32 and a vibration unit 49 is rotatably coupled to the second motor 48. The vibration unit 49 frictionally engages the associated massage unit 32 when the second motor 48 is turned on. Thus, the vibration unit 49 vibrates the associated massage unit 32 such that the vibration unit 49 enhances the massage. The second motor 48 may comprise an electric motor or the like.

A power switch 50 is coupled to the first half 26 and the power switch 50 may be manipulated. The power switch 50 is electrically coupled to the processor 42 such that the power switch 50 turns each of the first motor 44 and the second motor 48 on and off. A speed switch 52 is coupled to the second half 28 and the speed switch 52 may be manipulated. The speed switch 52 is electrically coupled to the processor 42. The speed switch 52 adjusts a speed of each of the first motor 44 and the second motor 48 between a minimum speed, a medium speed and a maximum speed.

A port 54 is coupled to the collar 12 and the port 54 may be electrically coupled to a power source 56. The port 54 may comprise a USB port and the power source 56 may comprise a USB cord. A power supply 58 is coupled to the collar 12. The power supply 58 is electrically coupled to the processor 42 and the port 54. The power supply 58 comprises at least one rechargeable battery 60. The port 54 charges the battery 60 when the port 54 is electrically coupled to the power source 56.

In use, the collar 12 is positioned in the deployed position and the collar 12 is worn on the head 14. The collar 12 is manipulated to position each of the massage units 32 on the associated temple 24. The power switch 50 is manipulated to turn the first motor 44 on and the second motor 48 on. The speed switch 52 is manipulated to select the minimum speed, the medium speed and the maximum speed. Each of the massage units 32 massages the associated temple 24 thereby relieving symptoms of a stress head ache, a migraine head ache or a head ache with an unknown cause. The collar 12 is worn on the head 14 for any selected duration of time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A massage assembly comprising:
a collar being configured to be worn on a head; and
a pair of massage units, each of said massage units being coupled to said collar wherein each of said massage units is configured to abut the head when said collar is worn on the head thereby facilitating each of said massage units to massage the head.

2. The assembly according to claim 1, wherein said collar has a first end, a second end and a front edge, said collar being curved between said first end and said second end such that said collar has a U-shape thereby facilitating said collar to be positioned on a crown of the head having said first end and said second end being aligned with an associated one of a pair of temples on the head.

3. The assembly according to claim 2, wherein said collar is split between said first end and said second end to define a first half and a second half of said collar, said collar including a pivot, each of said first half and said second half being movably coupled to said pivot, said collar being positionable in a deployed position having said first half being longitudinally aligned with said second half thereby forming said U-shape, said collar being positionable in a stored position having said front edge corresponding to said first half being positioned adjacent to said front edge corresponding to said second half.

4. The assembly according to claim 1, wherein:
said collar has a first end and a second end; and
each of said massage units has a first surface, each of said massage units being positioned on an associated one of said first end and said second end wherein said first surface is configured to frictionally engage an associated one of a pair of temples on the head thereby facilitating each of said massage units to massage an area proximate a temporal artery, said first surface of each of said massage units being comprised of a deformable material.

5. The assembly according to claim 1, wherein each of said massage units has a first surface, each of said massage units comprising a ring being rotatably positioned within said massage unit, said ring having a an inner edge.

6. The assembly according to claim 5, further comprising a plurality of balls, each of said balls being coupled to said ring, said balls being spaced apart from each other and distributed around said ring, each of said balls being positioned between said ring and said first surface wherein each of said balls is configured to urge said first surface to frictionally engage the head.

7. The assembly according to claim 6, further comprising:
a processor;
a first motor being positioned within said massage unit, said first motor being electrically coupled to said processor; and
a gear being rotatably coupled to said first motor, said gear engaging said inner edge such that said first motor rotates said ring when said first motor is turned on wherein said massage unit is configured to massage the associated temple.

8. The assembly according to claim 5, further comprising:
a second motor being positioned within said massage unit, said second motor being electrically coupled to said processor; and
a vibration unit being rotatably coupled to said second motor, said vibration unit frictionally engaging said massage unit when said second motor is turned on such that said vibration unit vibrates said massage unit wherein said vibration unit is configured to enhance the massage.

9. The assembly according to claim 1, further comprising:
said collar having a first half;
a processor; and
a power switch being coupled to said first half wherein said power switch is configured to be manipulated, said power switch being electrically coupled to said processor such that said power switch turns a first motor and a second motor on and off.

10. The assembly according to claim 9, further comprising:
said collar having a second half: and
a speed switch being coupled to said second half wherein said speed switch is configured to be manipulated, said speed switch being electrically coupled to said processor, said speed switch adjusting a speed of said first motor and said second motor between a minimum speed, a medium speed and a maximum speed.

11. The assembly according to claim 9, further comprising:
a port being coupled to said collar wherein said port is configured to be electrically coupled to a power source; and
a power supply being coupled to said collar, said power supply being electrically coupled to said first motor, said second motor and said port, said power supply comprising at least one rechargeable battery, said port charging said battery.

12. A massage assembly comprising:
a collar being configured to be worn on a head, said collar having a first end, a second end and a front edge, said collar being curved between said first end and said second end such that said collar has a U-shape thereby facilitating said collar to be positioned on a crown of the head having said first end and said second end being aligned with an associated one of a pair of temples on the head, said collar being split between said first end and said second end to define a first half and a second half of said collar, said collar including a pivot, each of said first half and said second half being movably coupled to said pivot, said collar being positionable in a deployed position having said first half being longitudinally aligned with said second half thereby forming said U-shape, said collar being positionable in a stored position having said front edge corresponding to said first half being positioned adjacent to said front edge corresponding to said second half; and
a pair of massage units, each of said massage units being coupled to said collar wherein each of said massage units is configured to abut the head when said collar is worn on the head thereby facilitating each of said massage units to massage the head, each of said massage units having a first surface, each of said massage units being positioned on an associated one of said first end and said second end wherein said first surface is configured to frictionally engage an associated one of the temples thereby facilitating each of said massage units to massage an area proximate a temporal artery, said first surface of each of said massage units being comprised of a deformable material, each of said massage units comprising:
a ring being rotatably positioned within said massage unit, said ring having an inner edge,
a plurality of balls, each of said balls being coupled to said ring, said balls being spaced apart from each other and distributed around said ring, each of said balls being positioned between said ring and said first surface wherein each of said balls is configured to urge said first surface to frictionally engage the head,
a processor being positioned within said massage unit,
a first motor being positioned within said massage unit, said first motor being electrically coupled to said processor,
a gear being rotatably coupled to said first motor, said gear engaging said inner edge such that said first motor rotates said ring when said first motor is turned on wherein said massage unit is configured to massage the associated temple,
a second motor being positioned within said massage unit, said second motor being electrically coupled to said processor,
a vibration unit being rotatably coupled to said second motor, said vibration unit frictionally engaging said massage unit when said second motor is turned on such that said vibration unit vibrates said massage unit wherein said vibration unit is configured to enhance the massage,
a power switch being coupled to said first half wherein said power switch is configured to be manipulated, said power switch being electrically coupled to said processor such that said power switch turns said first motor and said second motor on and off,
a speed switch being coupled to said second half wherein said speed switch is configured to be manipulated, said speed switch being electrically coupled to said processor, said speed switch adjusting a speed of said first motor and said second motor between a minimum speed, a medium speed and a maximum speed,
a port being coupled to said collar wherein said port is configured to be electrically coupled to a power source, and
a power supply being coupled to said collar, said power supply being electrically coupled to said processor and said port, said power supply comprising at least one rechargeable battery, said port charging said battery.
